(19) United States
(12) Patent Application Publication
(10) Pub. No.: US 2025/0389827 A1
(43) Pub. Date: Dec. 25, 2025

(54) MEASUREMENT APPARATUS, MEASUREMENT SYSTEM, AND MEASUREMENT METHOD

(71) Applicant: FUJIFILM Corporation, Tokyo (JP)

(72) Inventor: Yuya ISHIZUKA, Kanagawa (JP)

(73) Assignee: FUJIFILM Corporation, Tokyo (JP)

(21) Appl. No.: 19/313,844

(22) Filed: Aug. 28, 2025

Related U.S. Application Data
(63) Continuation of application No. PCT/JP2024/004466, filed on Feb. 9, 2024.

(30) Foreign Application Priority Data
Mar. 3, 2023 (JP) 2023-033150

(51) Int. Cl. G01S 7/493; G01S 17/42; G01S 17/89

(52) U.S. Cl. CPC G01S 7/493; G01S 17/42; G01S 17/89

(57) ABSTRACT

The present disclosure enables to correct a Doppler shift with high accuracy. In the measurement apparatus according to one aspect of the present invention, the processor acquire first scan data including information indicating a first distance, which is a distance from a laser scanner to a measure portion of an object, obtained by scanning the measure portion in a first direction with the laser scanner; acquire second scan data including information indicating a second distance, which is a distance from the laser scanner to the measure portion of the object, obtained by scanning the measure portion in a second direction different from the first direction with the laser scanner; and calculate corrected data in which an influence of a Doppler shift in the first scan data and the second scan data is removed by applying an averaging processing to the first scan data and the second scan data.

### CROSS-REFERENCE TO RELATED APPLICATIONS

The present application is a Continuation of PCT International Application No. PCT/JP2024/004466 filed on Feb. 9, 2024 claiming priority under 35 U.S.C § 119(a) to Japanese Patent Application No. 2023-033150 filed on Mar. 3, 2023. Each of the above applications is hereby expressly incorporated by reference, in its entirety, into the present application.

### BACKGROUND OF THE INVENTION

### 1. Field of the Invention

The present invention relates to a measurement apparatus, a measurement system, and a measurement method, and particularly to a technique for measuring an object using laser light.

### 2. Description of the Related Art

In recent years, inspection and maintenance (grasping condition of a structure, repair according to the condition, and the like) of so-called “social infrastructure structures” such as roads, bridges, tunnels, dams, and buildings, specifically, presence or absence of defects (or damage) such as cracks, “delamination”, and peeling, and the degree thereof have become a major social problem. It should be noted that “infra” is an abbreviation for “infrastructure”.

In the related art, a worker has confirmed the defect of an object by visual observation or tapping. However, such work takes time and effort, and it may be difficult to approach an inspection target.

In response to such circumstances, a technique for measuring the object in a non-contact manner using laser light has been considered to detect the defect based on measurement of minute unevenness (three-dimensional shape). In such measurement, in a case where a social infrastructure structure is a target, high-speed scanning and high-accuracy detection are required depending on the type, size, and the like of the object. However, there is a problem in that measurement accuracy (distance measurement accuracy) is reduced due to a Doppler shift in a case where a scanner and a measurement object are moving relative to each other.

As a technique for dealing with such a problem, for example, JP2020-046368A is known. JP2020-046368A describes a technique for correcting the Doppler shift in a situation in which a measurement head is fixed to a moving measurement object. Specifically, a sample of an object to be measured is moved at a plurality of speeds, a difference between the moving speeds is calculated as a speed for correction, and a difference between frequencies of reflected light at the moving speeds is calculated as a frequency shift amount.

### SUMMARY OF THE INVENTION

In a case where measurement is performed using laser light, depending on a type and size of a measurement target (for example, in a case where the measurement target is a social infrastructure structure), it may be difficult (practically impossible) to move or rotate the measurement target itself and in this case, the optical axis direction changes with the scanning, and the measurement angle changes. However, such circumstances are not taken into account in JP2020-046368A. In addition, depending on the measurement target, it is difficult to perform the pre-measurement in the entire measurement unit as in JP2020-046368A and measure an angle at each point of the obtained point group. In addition, depending on the measurement target, it is also difficult to accurately measure aiming at the same place for two measurements with different speeds.

As described above, in the related art, it is difficult to correct the Doppler shift due to the change in the scan direction.

The present invention has been made in view of such circumstances, and an object of the present invention is to provide a measurement apparatus, a measurement system, and a measurement method capable of accurately correcting a Doppler shift.

In order to achieve the above-described object, a measurement apparatus according to a first aspect of the present invention is a measurement apparatus comprising a processor, in which the processor is configured to: acquire first scan data including information indicating a first distance, which is a distance from a laser scanner to a measure portion of an object, obtained by scanning the measure portion in a first direction with the laser scanner; acquire second scan data including information indicating a second distance, which is a distance from the laser scanner to the measure portion of the object, obtained by scanning the measure portion in a second direction different from the first direction with the laser scanner; and calculate corrected data from which influence of a Doppler shift in the first scan data and the second scan data has been removed by applying an averaging processing to the first scan data and the second scan data.

In the first aspect, the first direction and the second direction may change over time. That is, the first and second scan data are time-series data, and a measurement result includes a deviation from a true value due to the Doppler shift. Here, since the scanning directions (the first direction and the second direction) of the first scan data and the second scan data are different, it is considered that signs of the deviation from a true value due to the Doppler shift are reversed in the measurement result. Therefore, in a case where the first scan data and the second scan data are averaged, the influence of the Doppler shift can be canceled. In the first aspect and each of the following aspects, the first direction and the second direction may be opposite directions, but do not have to be completely opposite directions.

As described above, with the measurement apparatus according to the first aspect, the Doppler shift can be corrected with high accuracy.

In the first aspect and each of the following aspects, the first and second scan data may include data of a distance and data of a scan direction (for example, an azimuthal angle and an elevation angle or a main scanning direction and a sub-scanning direction), or may include data of a three-dimensional position. The distance and the scan direction are equivalent information that can be converted into the three-dimensional position.

In addition, the measurement apparatus according to the first aspect can be realized as, for example, a processor portion (a portion that acquires and processes measurement data) of the measurement system, but the present invention is not limited to such an aspect.

In the measurement apparatus according to a second aspect, in the first aspect, the processor is configured to apply the averaging processing according to a distance between a first measurement point at which the first scan data is acquired and a second measurement point at which the second scan data is acquired. For example, different averaging processing can be applied in a case where the distance between the first measurement point and the second measurement point is short and a case where the distance between the first measurement point and the second measurement point is long.

In the measurement apparatus according to a third aspect, in the second aspect, the processor is configured to average a position of the first measurement point and a position of the second measurement point in the averaging processing. In the third aspect, the “average” may be a simple average or a weighted average.

In the measurement apparatus according to a fourth aspect, in the first or second aspect, the processor is configured to: acquire the first scan data by including a first speed, which is a speed of the scanning, for each measurement point of a first measurement point group for acquiring the first scan data; acquire the second scan data by including a second speed, which is a speed of the scanning, for each measurement point of a second measurement point group for acquiring the second scan data; and apply the averaging processing to the first scan data and the second scan data by using the first speed and the second speed.

In the measurement apparatus according to a fifth aspect, in the fourth aspect, the processor is configured to, in the averaging processing, calculate, as the corrected data, a position obtained by internally dividing a position of a first point, which is a point selected from the first measurement point group, and a position of a second point, which is a point selected from the second measurement point group, in a ratio of an absolute value of the first speed at the first point to an absolute value of the second speed at the second point.

In the measurement apparatus according to a sixth aspect, in the fifth aspect, the processor is configured to perform the averaging processing using an internal division ratio of 1:1. The sixth aspect defines a specific method of the averaging processing.

In the measurement apparatus according to a seventh aspect, in the fifth or sixth aspect, the processor is configured to perform the averaging processing for all pairs of two points that are a pair of the first point and the second point and for which a distance difference between the first point and the second point is equal to or less than a reference value. A seventh aspect defines a selection method for data to be subjected to the averaging processing.

In the measurement apparatus according to an eighth aspect, in the fifth or sixth aspect, the processor is configured to perform the averaging processing for each pair of pair of a point in the first measurement point group and one or a plurality of the second points selected from the second measurement point group in ascending order of distance from the first point. The eighth aspect defines another selection method for data to be subjected to the averaging processing.

In the measurement apparatus according to a ninth aspect, in the fifth or sixth aspect, the processor is configured to perform the averaging processing for each pair of the second point and one or a plurality of the first points selected from the first measurement point group in ascending order of distance from the second point. A ninth aspect defines another selection method for data to be subjected to the averaging processing.

In the measurement apparatus according to a tenth aspect, in any one of the first to ninth aspects, the processor is configured to measure a three-dimensional shape of the object by using a plurality of pieces of the corrected data. In addition, the processor may evaluate damage (defect) such as delamination or peeling based on the measurement result.

In the measurement apparatus according to an eleventh aspect, in the tenth aspect, the processor is configured to extract a damage candidate region of the object based on the measured three-dimensional shape and to output information indicating the extracted damage candidate region to an output device. The output device may be a display device or a recording device.

In the measurement apparatus according to a twelfth aspect, in the eleventh aspect, the processor is configured to extract, as the damage candidate region, a region in which a deviation from design information of the three-dimensional shape of the object and/or a measurement result of the three-dimensional shape acquired in advance exceeds a reference. In the twelfth aspect, the “design information” may be, for example, data of a computer aided design (CAD) system, and the “measurement result of the three-dimensional shape acquired in advance” may be, for example, a measurement result in the past. In addition, for example, a predetermined threshold value can be used as a “reference”.

In order to achieve the above-described object, a measurement system according to a thirteenth aspect of the present invention comprises the measurement apparatus according to any one of claims first to twelfth; and the laser scanner. In the measurement system according to the thirteenth aspect, the measurement apparatus according to any one of the first to twelfth aspects is provided, so that the Doppler shift can be accurately corrected. In the thirteenth aspect, it is preferable that the laser scanner outputs information indicating the distance and information indicating a laser irradiation direction in association with each other. The measurement apparatus can use this output.

In the measurement system according to a fourteenth aspect, in the thirteenth aspect, the laser scanner is a laser scanner using laser light of a frequency-modulated continuous wave method. A “frequency-modulated continuous wave laser” (hereinafter, may be referred to as “FMCW laser”) is a laser light that transmits a frequency-modulated continuous wave, and a distance to an object can be obtained based on a frequency difference (beat frequency) between a transmitted wave and a reflected wave. In the measurement using the frequency-modulated continuous wave laser light, distance resolution is determined by “the amount of frequency change (chirp rate) per unit time and measurement resolution of the beat frequency”.

In the measurement system according to a fifteenth aspect, in the fourteenth aspect, the laser scanner is a laser scanner using frequency-shifted feedback type laser light. A “frequency-shifted feedback laser (hereinafter, may be referred to as “FSF laser”)” is a type of frequency-modulated continuous wave laser.

In order to achieve the above-described object, according to a sixteenth aspect of the present invention, there is provided a measurement method executed by a measurement apparatus comprising a processor, the measurement method comprising: acquiring first scan data including information indicating a first distance, which is a distance from a laser scanner to a measure portion of an object, obtained by scanning the measure portion in a first direction with the laser scanner; acquiring second scan data including information indicating a second distance, which is a distance from the laser scanner to the measure portion of the object, obtained by scanning the measure portion in a second direction different from the first direction with the laser scanner; and calculating corrected data in which an influence of a Doppler shift in the first scan data and the second scan data is removed by applying an averaging processing to the first scan data and the second scan data. According to the sixteenth aspect, the Doppler shift can be corrected with high accuracy as in the first aspect.

The measurement method according to the sixteenth aspect may comprise the same configuration as the second to twelfth aspects. In addition, a program for causing a measurement apparatus comprising a processor to execute the measurement method of these aspects, and a non-transitory and tangible recording medium (for example, various magneto-optical recording devices or semiconductor memories) in which a computer-readable code of such a program is recorded can also be included in the aspect of the present invention. The “non-transitory and tangible recording medium” does not include a non-tangible recording medium such as a carrier wave signal or a propagation signal itself.

As described above, according to the measurement apparatus, the measurement system, and the measurement method of the embodiment of the present invention, the Doppler shift can be accurately corrected.

### BRIEF DESCRIPTION OF THE DRAWINGS

FIG. 1 is a diagram showing a configuration of a measurement system according to a first embodiment.

FIG. 2 is an external view of a three-dimensional measurement apparatus according to the first embodiment.

FIG. 3 is a diagram showing a configuration of the three-dimensional measurement apparatus.

FIG. 4 is a diagram showing an example of two-dimensional scanning.

FIG. 5 is a diagram showing another example of the two-dimensional scanning.

FIG. 6 is a diagram showing a hardware configuration of a data processing apparatus.

FIG. 7 is a flowchart (1/2) showing processing of a measurement method.

FIG. 8 is a flowchart (2/2) showing processing of the measurement method.

FIGS. 9A and 9B are diagrams showing a state in which correction is performed using measurement results in a clockwise direction and a counterclockwise direction.

FIG. 10 is a diagram showing a state in which data is acquired at each measurement point by scanning.

FIG. 11 is a diagram showing a state of correction of a distance using speed data.

FIG. 12 is a diagram showing a visual line direction speed and a tangent direction speed in a case where a scan direction is different.

FIG. 13 is a diagram showing a state in which influence of a Doppler shift is canceled by reverse-direction scanning.

FIG. 14 is a diagram showing an output example of a damage candidate region.

### DESCRIPTION OF THE PREFERRED EMBODIMENTS

### Influence of Doppler Shift in Measurement

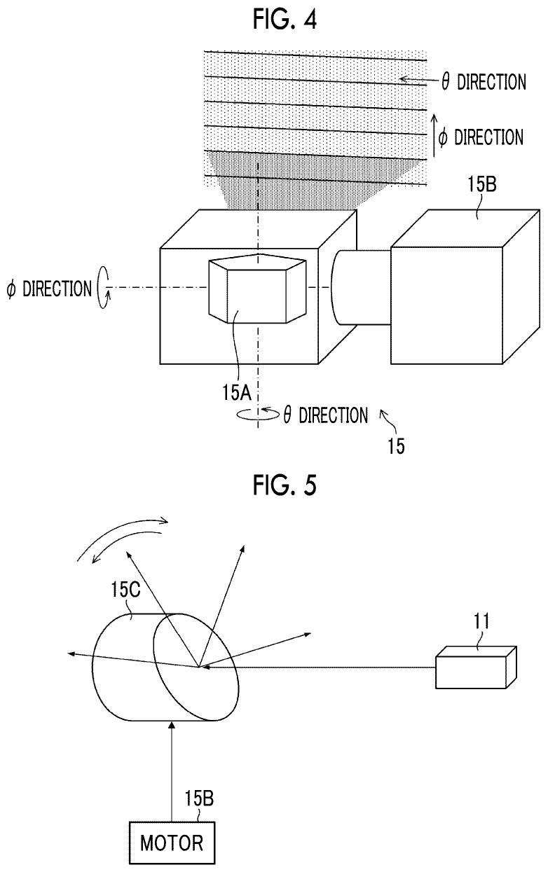

In the measurement using laser light, it is difficult to measure the same point multiple times as described above, and in a case where an asymmetric mirror (see examples in FIGS. 4 and 5) is used to change an irradiation direction of the laser light, the rotation speed may change slightly depending on the rotation position. Due to such circumstances, a relative distance or a relative speed with a measurement object may change in a process of scanning, and a distance measurement accuracy (measurement accuracy) may decrease due to influence of the Doppler shift. In response to such a problem, depending on conditions such as the type and size of the object, it is difficult to perform the movement of the object or the scanning at a plurality of speeds as described above for JP2020-046368A, or to completely measure the same point.

In view of such circumstances, the present inventors have conducted intensive studies and have obtained an idea that “in the forward scanning and the backward scanning, the signs of the deviation from the true value due to the Doppler shift in the measurement data should be reversed, and thus, in a case where the measurement result obtained by the forward scanning and the measurement result obtained by the backward scanning are averaged, the influence of the Doppler shift is canceled out, and the distance (three-dimensional shape) can be measured with high accuracy”. Hereinafter, embodiments of the present invention based on such an idea will be described.

### First embodiment

A first embodiment of a measurement apparatus, a measurement system, and a measurement method according to the present invention will be specifically described.

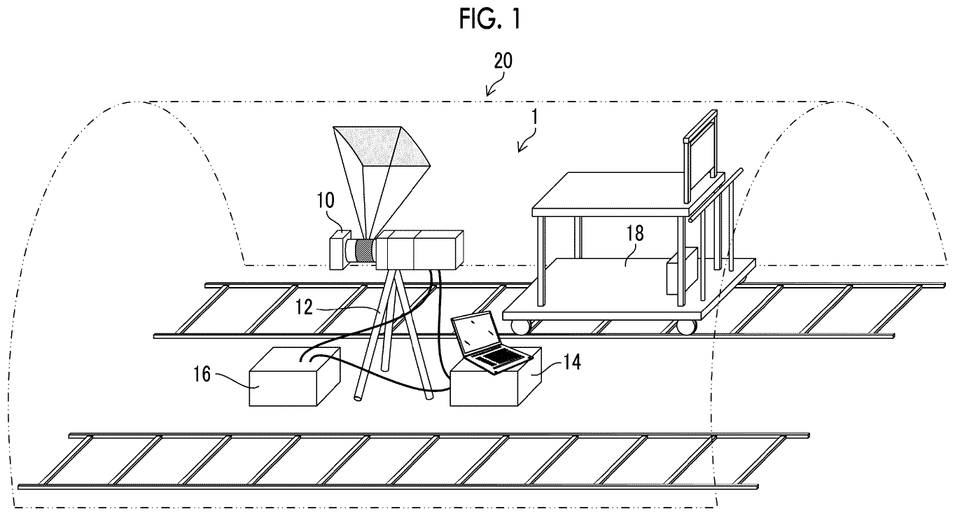

FIG. 1 is a diagram showing a configuration of a measurement system according to a first embodiment. As shown in FIG. 1, a measurement system 1 (measurement system) is a system that measures and inspects a tunnel of a railway, and comprises a three-dimensional measurement apparatus 10 (laser scanner), a data processing apparatus 14 (measurement apparatus, processor), and a power supply device 16.

The three-dimensional measurement apparatus 10 is a light detection and ranging (LiDAR) in this example, and is particularly a frequency modulated continuous wave (FMCW) LiDAR that can measure a distance with an accuracy of an order of several hundred um. However, the present invention is not limited to a case where distance measurement data (three-dimensional measurement data) measured by the FMCW LiDAR is used. The three-dimensional measurement apparatus 10 is mounted on the tripod 12, but may be mounted on the cart 18 that travels or moves on the track.

### Three-Dimensional Measurement Apparatus

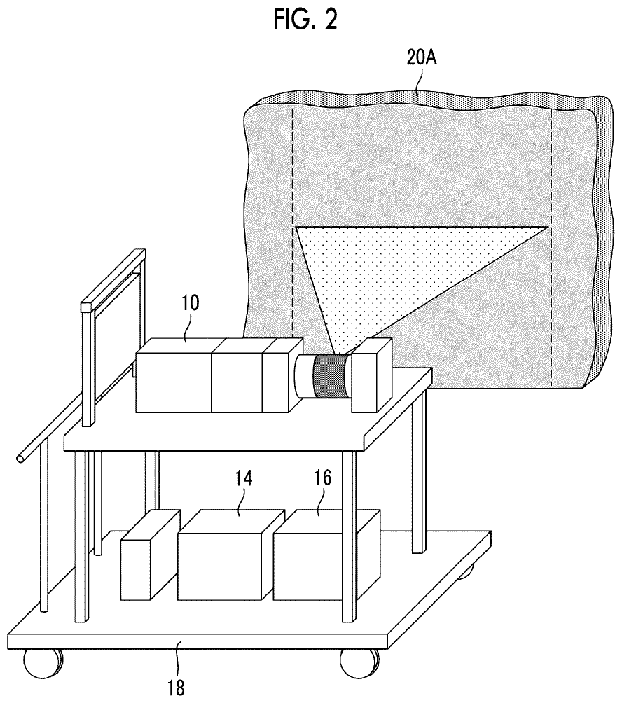

FIG. 2 is an external view of a three-dimensional measurement apparatus 10 according to the first embodiment. The three-dimensional measurement apparatus 10 includes a LiDAR of a frequency modulation continuous wave (FMCW) type. As shown in FIG. 2, the three-dimensional measurement apparatus 10 is mounted on the cart 18 that travels on a railroad track and measures a distance to a wall surface 20A (object, measure portion) of a tunnel 20 (object). A data processing apparatus 14 (processor) and a power supply device 16 are mounted on the cart 18 in addition to the three-dimensional measurement apparatus 10. The power supply device 16 supplies power to the three-dimensional measurement apparatus 10 and the data processing apparatus 14.

In the measurement system 1, the distance and the direction to the wall surface 20A and the rate of change thereof can be measured by the three-dimensional measurement apparatus 10 or the like, and the three-dimensional shape of the wall surface 20A (object) can be measured using a plurality of pieces of corrected data as will be described in detail later.

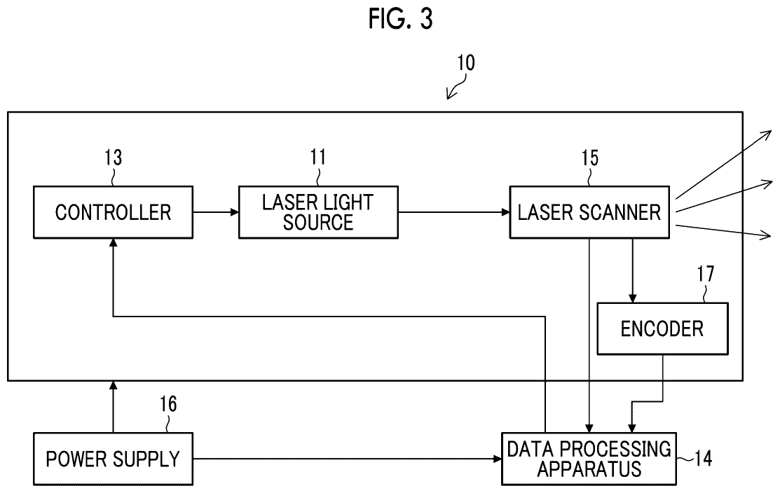

In the example shown in FIG. 2, the three-dimensional measurement apparatus 10 scans the laser light of an FSF method as one aspect of the FMCW method at a high speed in a left-right direction (main scanning direction) of the wall surface 20A shown in FIG. 2, and scans the laser light by moving the scanning line in an up-down direction (sub-scanning direction) of the wall surface 20A. Thus, a distance from the laser scanner 15 of the three-dimensional measurement apparatus 10 (see FIG. 3) to a number of measurement points on each scanning line of the laser light is measured. In the measurement result, averaging processing is applied to remove the influence of the Doppler shift, and the corrected data is calculated, as will be described in detail later. Then, three-dimensional data of a polar coordinate system including the irradiation direction of the laser light and the measured distance is converted into three-dimensional data of a rectangular coordinate system to acquire three-dimensional measurement data indicating the three-dimensional shape of the wall surface 20A. In the present example, three-dimensional measurement data (point cloud data) of a large number of measurement points is acquired as the three-dimensional measurement data.

### FSF Type Laser Device

FIG. 3 is a diagram showing a configuration of the three-dimensional measurement apparatus 10. The three-dimensional measurement apparatus 10 uses an FSF (frequency shifted feedback) type laser device which is one aspect of the FMCW method, and comprises a laser light source 11 that outputs frequency shifted feedback laser light (FSF laser light), a control unit 13 of the laser light source 11, a laser scanner 15 (laser scanner), and an encoder 17. The laser light source 11 includes a laser medium, a mirror, an acousto-optic modulator (AOM), and the like. However, as described in JP2021-096383A, an optical single side band (SSB) modulator may be used as a frequency shifter.

### Scanning by Rotation of Mirror

The laser scanner 15 scans the wall surface 20A (object) in the main scanning direction and the sub-scanning direction with the laser light output from the laser light source 11 (two-dimensional scanning). FIG. 4 is a diagram showing an example of such two-dimensional scanning. As shown in FIG. 4, the laser scanner 15 changes the irradiation direction of the laser light (a reflection direction of the laser light by a polygonal mirror 15A) to a θ direction (main scanning direction) and a o direction (sub-scanning direction) by rotating the polygonal mirror 15A (an example of a scanning direction changing member) in two axes by the motor 15B. The laser scanner 15 comprises a light receiver (not shown) and receives the laser light reflected by the wall surface 20A.

In such a two-dimensional scanning, for example, after acquiring first scan data by scanning in a forward direction (first direction) in both the θ direction and the φ direction (first measurement), second scan data can be acquired by scanning in a direction opposite to the forward direction (second direction) in both the θ direction and the φ direction (second measurement).

FIG. 5 is a diagram showing another example of the two-dimensional scanning. In the example shown in the drawing, the irradiation direction of the laser light output from the laser light source 11 is changed by rotating the monogon mirror 15C (tilt mirror; another example of the scanning direction changing member) in the forward direction (first direction) or the backward direction (second direction) by the motor 15B. In such an aspect, in a case where the tilt angle of the monogon mirror 15C can be changed around the two axes, the forward scan and the backward scan can be performed as in the example described above with reference to FIG. 4. In addition, even in a case where the tilt angle of the monogon mirror 15C can be changed only around one axis (for example, the φ direction), the entire wall surface 20A can be scanned by repeating the one-dimensional scanning in accordance with the running or movement of the cart 18.

### Acquisition of Data on Distance, Speed, and Direction

In addition, the three-dimensional measurement apparatus 10 comprises an encoder 17 (angle detector) that detects the rotation angle of the mirror. The data processing apparatus 14 (or the measurement apparatus 100) can calculate the irradiation direction (main scanning direction and sub-scanning direction) of the laser light from the output of the encoder 17, and can calculate the speed of scanning (which may be an orthogonal coordinate system or a polar coordinate system) from the change in the irradiation direction and the measured distance. Accordingly, the data processing apparatus 14 (or the measurement apparatus 100) can acquire the measured distance (the first distance and the second distance), the speed of scanning (the first speed and the second speed), and the direction of scanning (the main scanning direction and the sub-scanning direction) in association with each measurement point on the wall surface 20A. Since the three-dimensional position can be calculated from the distance and the direction to the measurement point, the acquisition of the distance, the direction, and the speed in association with each other is equivalent to the acquisition of the three-dimensional position and the speed in association with each other.

### Example of Measurement Conditions

It is considered that the three-dimensional measurement apparatus 10 performs measurement of a minute uneven shape (three-dimensional shape) of the wall surface 20A under, for example, the following conditions.
Measurement accuracy: 50 μm
Measurement distance: 2 to 7 m
Measurement speed: 10 m²/sec for area

The scan speed of the laser light itself is, for example, about 4,000 rpm, but the scan speed in a case where the scanning direction is reciprocated (after scanning in the forward direction, scanning is performed in the reverse direction) is, for example, about 60 rpm. In addition, for example, the three-dimensional measurement apparatus 10 acquires the three-dimensional data of the wall surface 20A at a regular interval during the movement of the cart 18, but it is preferable to acquire the three-dimensional data such that the measurement region of the three-dimensional data acquired at each interval partially overlaps. This is for panorama composition of the three-dimensional data acquired in each interval.

The three-dimensional measurement apparatus 10 is configured as a LIDAR of the FSF system (an example of an FMCW system) to realize the above-described measurement accuracy and the like.

The conditions such as the measurement accuracy of the three-dimensional measurement data required in the present invention are not limited to the above example, and various three-dimensional measurement apparatus can be applied without being limited to the FSF type LiDAR. For example, laser light of the FMCW method may be generated using a DFB (distributed feedback) semiconductor laser, a Fabry-Perot type semiconductor laser, a surface-emitting semiconductor laser, or the like, in addition to the FSF laser light. For example, in a case where a drive current waveform of a semiconductor laser is controlled by a sawtooth wave or a triangular wave, the frequency changes according to the change in the current, so that the semiconductor laser operates as a frequency-modulated continuous wave laser.

It is preferable that the three-dimensional shape of the wall surface 20A is measured by the three-dimensional measurement apparatus 10 at the start of measurement (construction) of the tunnel and at the time of regular inspection after construction. The three-dimensional measurement data can be recorded in the recording device 160 in the data processing apparatus 14 and/or an external recording device at the start of measurement and during regular inspection. The recording device 160 and/or the external recording device may record design information (CAD data or the like) of the tunnel 20 (object). As will be described in detail later, such design information or past measurement results (measurement results of the three-dimensional shape acquired in advance) can be used for extracting the damage candidate region.

### Hardware Configuration of Measurement Apparatus

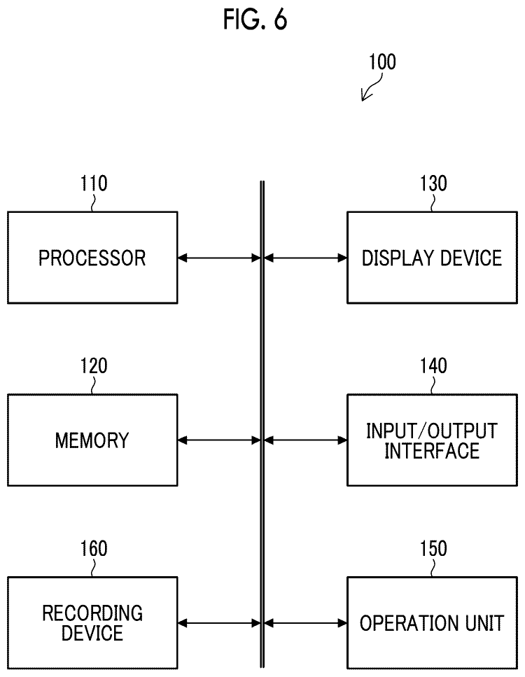

FIG. 6 is a diagram showing a hardware configuration of the measurement apparatus 100 (measurement apparatus). As shown in FIG. 6, the measurement apparatus 100 functions as a data processing portion (processor portion) of the measurement system 1, and is composed of, for example, a personal computer, a workstation, or the like. The measurement apparatus 100 comprises a processor 110, a memory 120, a display device 130 (output device), an input/output interface 140, an operation unit 150, and a recording device 160 (output device). The measurement apparatus 100 can be incorporated as one function of the data processing apparatus 14 shown in FIGS. 1 to 3.

The processor 110 (processor) is configured of a central processing unit (CPU) or the like, and is capable of integrally controlling each unit of the measurement apparatus 100 and the measurement system 1 and executing a distance measurement program, a distance correction program, a shape measurement program, a damage evaluation program, and the like. Details of various types of processing performed by the processor 110 will be described below.

The memory 120 includes a flash memory, a read-only memory (ROM), a random access memory (RAM), and the like. The flash memory and the ROM are non-volatile memories (tangible and non-transitory recording media) that store an operating system, various programs including a measurement program according to the present invention, and the like.

The RAM functions as a work area of processing by the processor 110. In addition, various programs stored in the flash memory or the like and three-dimensional measurement data of a surface of the wall surface 20A (object, building) are temporarily stored. Meanwhile, a part (RAM) of the memory 120 may be built in the processor 110.

The display device 130 can display a measurement result calculated by the measurement apparatus 100, a graph, a table, a surface property image of a building, and the like created based on the measurement result, in addition to displaying a screen for operating the measurement apparatus 100. The display device 130 is also used as a part of a graphical user interface (GUI) in a case where an input (designating a point of interest on a surface of a building or the like) of a user is received via the operation unit 150. The display device 130 may be configured by a touch panel type device, and the device may receive the operation of the user.

The input/output interface 140 includes a connection unit that can be connected to an external device, a communication unit that can be connected to a network, and the like. As the connection unit that is connectable to the external device, a universal serial bus (USB), a high-definition multimedia interface (HDMI) (HDMI is a registered trademark), and the like can be applied. The measurement apparatus 100 can acquire scan data and the like necessary for measurement from an external device (another system or a recording device) present on the Internet or on the cloud, or from a recording medium, via the input/output interface 140.

The measurement apparatus 100 can also be configured as an apparatus independent of the data processing apparatus 14. In this case, the processor 110 acquires the three-dimensional measurement data of the surface of the building from the data processing apparatus 14 via the input/output interface 140, or in a case where the three-dimensional measurement data is stored in a database or the like on the cloud, acquires the three-dimensional measurement data of the surface of the building from the cloud via the input/output interface 140. In addition, the processor 110 can record the three-dimensional measurement data acquired in this way in the memory 120 or the recording device 160.

The operation unit 150 includes a device such as a mouse or a keyboard, and functions as a part of the GUI that receives an instruction input by a user operation using a display screen of the display device 130.

The recording device 160 is composed of a non-transitory and tangible recording medium such as a flash memory, a hard disk device, and a magneto-optical recording device, and a control unit thereof, and three-dimensional measurement data (measurement result of three-dimensional shape acquired in advance) of the surface of the building measured by the three-dimensional measurement apparatus 10 at the start of measurement of the building and at the time of regular inspection is stored together with information indicating the date and time of measurement. Design information (CAD data or the like) of the three-dimensional shape of the tunnel 20 (object) may be recorded in the recording device 160. In addition, the recording device 160 can record various types of data (a data selection method and the like described below), measurement results (first/second scan data and the like) at each measurement point, data processing results (corrected data, measurement results of a three-dimensional shape, damage candidate region, and the like), and the like necessary for processing.

### Processing of Measurement Method

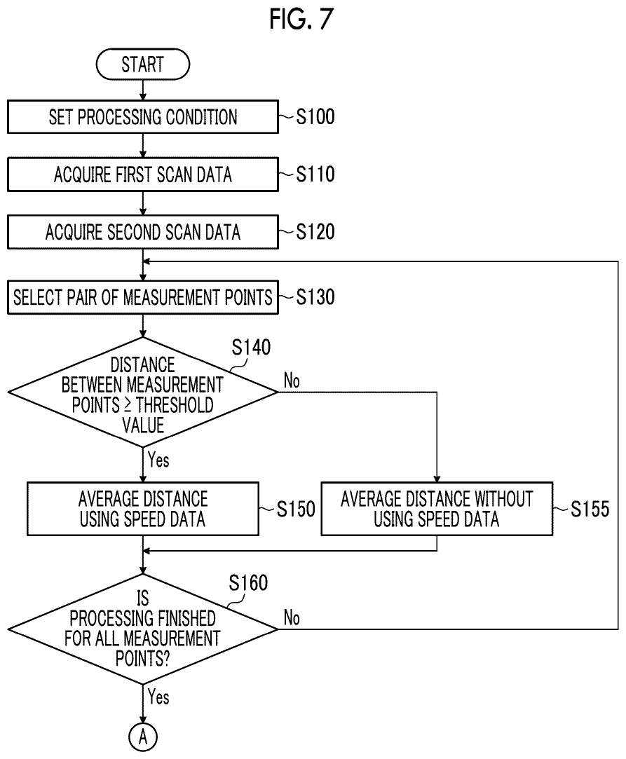

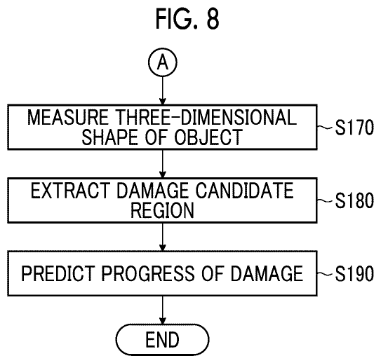

Next, a measurement method in the measurement system 1 having the above-described configuration will be described. FIGS. 7 and 8 are flowcharts showing processing of a measurement method according to an aspect of the present invention. In the following, a case where the measurement apparatus 100 is incorporated as one function of the data processing apparatus 14 and the processor 110 (processor) mainly executes processing will be described. In a case where the measurement apparatus 100 is an independent device from the data processing apparatus 14, the following processing may be shared and executed by the data processing apparatus 14 and the measurement apparatus 100.

### Setting of Processing Condition

The processor 110 (processor) sets a processing condition for measurement (step S100). This processing condition may include a scanning condition (scanning range, pitch, irradiation pattern of laser light, and the like) in a case where new scanning is performed. Alternatively, in a case where measurement is performed using data acquired in advance, the processing condition may include designation of data to be processed. In addition, the processing condition may include designation of a method (described below) of selecting a point to be subjected to the averaging processing from the measurement point group. The processor 110 may set the processing condition based on the operation of the user through the operation unit 150, or may set the processing condition according to a predetermined condition regardless of the operation of the user. Some conditions, such as a method of selecting the target point, may be performed in the middle of the processing described below (for example, in step S130).

### Acquisition of Scan Data

The processor 110 acquires the first scan data and the second scan data (steps S110 and S120). The first scan data includes a first distance that is a distance from the laser scanner 15 to the measure portion of the wall surface 20A (object) obtained by scanning the measure portion with the laser scanner 15 (laser scanner) in the first direction, and the second scan data includes a second distance that is a distance from the laser scanner 15 to the measure portion of the wall surface 20A obtained by scanning the measure portion with the laser scanner 15 in the second direction. As described above, the processor 110 may acquire the first and second scan data by newly performing the scan, or may acquire the data recorded in advance in the recording device such as the recording device 160.

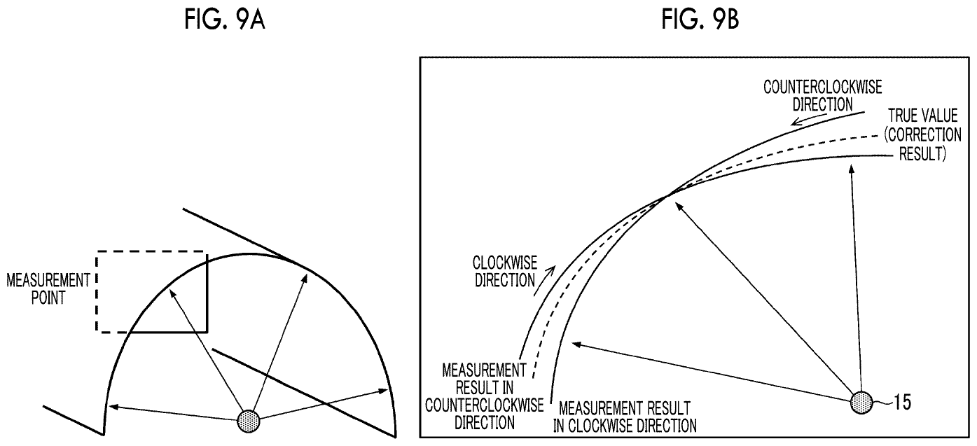

FIGS. 9A and 9B are diagrams showing a state in which correction is performed using measurement results in a clockwise direction and a counterclockwise direction. FIG. 9A is a diagram showing a state in which scanning is performed at a traveling position (measurement point) of the tunnel 20, and FIG. 9B is a diagram showing a state in which scan data (measurement result) is acquired and a corrected result is obtained by setting a clockwise direction (forward direction) as the first direction and a counterclockwise direction opposite to the clockwise direction as a second direction. The scanning method is not limited to such an example, and the first direction and the second direction need only be different. Even in a case where the second direction is a direction different from the perfect counterclockwise direction (even in a case where the second direction is not a direction completely opposite to the first direction), the processing can be performed by regarding such a second direction as “perfect counterclockwise (completely opposite to the first direction)” depending on allowable correction accuracy.

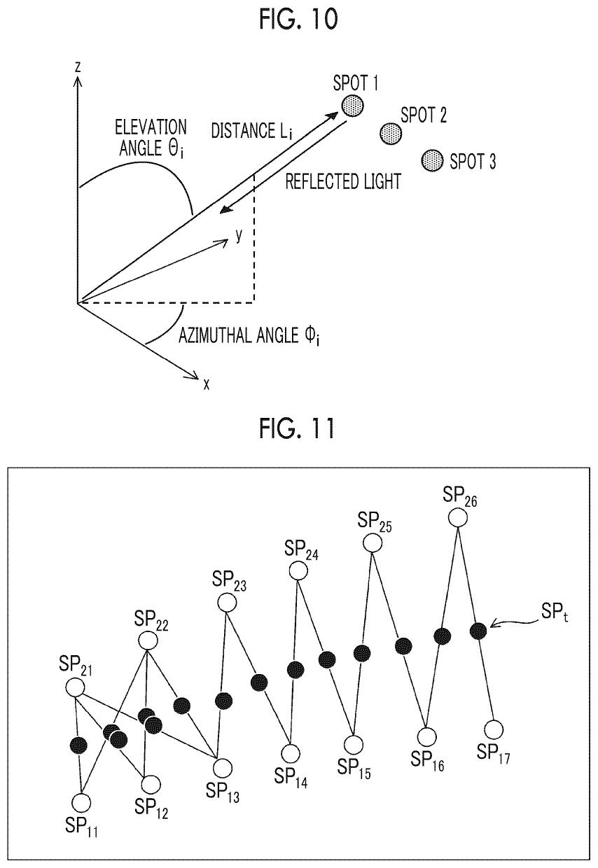

FIG. 10 is a diagram showing a state in which data is acquired at each measurement point by scanning. In the example shown in the FIG. 10, for the i-th spot (measurement point) (i is an integer of 1 or more), (distance Lᵢ, elevation angle Θᵢ, azimuthal angle Φᵢ) are acquired in association with each other (acquisition of first scan data and second scan data). The distance Lᵢ is a distance from the laser scanner 15 to the i-th spot (measure portion on the wall surface 20A), and is the first distance in the first scan and the second distance in the second scan.

The processor 110 acquires such data in each of the first direction scan and the second direction scan. It should be noted that the entire measurement points at which data is acquired by the first direction scan and the second direction scan are referred to as a first measurement point group and a second measurement point group, respectively.

The processor 110 can acquire the rate of change (first speed, second speed) of (distance, elevation angle, azimuthal angle) in association with each measurement point of the first measurement point group and the second measurement point group. It should be noted that (distance, elevation angle, azimuthal angle) are equivalent to three-dimensional coordinates (x, y, z), and a rate of change of (distance, elevation angle, azimuthal angle) is equivalent to a three-dimensional speed (Vx, Vy, Vz). In addition, the processor 110 can calculate the visual line direction speed Vᵣ and the tangent direction speed Vₜ at each measurement point from these data.

### Selection of Pair of Measurement Points

The processor 110 selects a pair of measurement points for performing correction (step S130). The selection can be performed by, for example, the following method. The processor 110 may decide which method is used for the selection based on the operation of the user through the operation unit 150, or may decide without depending on the operation of the user. In addition, this determination may be performed in step S130 or may be performed in step S100 described above.

### Selection Method 1

The processor 110 performs the averaging processing to all pairs of two points in which a distance difference between the first point (point selected from the first measurement point group) and the second point (point selected from the second measurement point group) is equal to or less than the reference value. Since it is considered that the pair in which the difference in distance is equal to or less than the reference value is likely to be a corresponding point (a point that should be measured as the same point in principle), such a pair is selected in the selection method 1. The “reference value” is a reference value for the pair selection, and may be a value different from the “threshold value” described below.

### Selection Method 2

The processor 110 performs averaging processing to a pair of a point (first point) in the first measurement point group and one or a plurality of second points selected from the second measurement point group in ascending order of distance from the first point. In the selection method 2, the second point is selected with the first point as a reference.

### Selection Method 3

The processor 110 performs the averaging processing for each pair of the second point and one or a plurality of first points selected from the first measurement point group in ascending order of the distance from the second point. In the selection method 3, the first point is selected with the second point as a reference, contrary to the selection method 2.

### Correction According to Distance Between Measurement Points

In the first embodiment, as will be described below, correction (averaging processing) is performed according to the distance between the selected measurement points (the distance between the first measurement point and the second measurement point). That is, in a case where the distance between the measurement points is short, the averaging processing is performed without using the speed data, and in a case where the distance is long, the averaging using the speed data is performed. This is because, in a case where the distance between the measurement points is short, the correction accuracy is good even without using the speed data. In addition, this is because the correction can be performed at a high speed by such processing. However, the averaging processing in the present invention is not limited to such an aspect, and correction may be performed with high accuracy by performing averaging using the speed data for all the pairs.

Specifically, the processor 110 determines whether or not the distance between the measurement points is equal to or greater than the threshold value (step S140), and in a case where the distance is short (in a case where the distance is less than the threshold value; NO in step S140), the processor 110 proceeds to step S155 to perform the averaging processing without using the speed data.

### Averaging Processing in Case Where Distance Between Measurement Points is Less Than Threshold Value

It is assumed that a position of the first measurement point is (x₁, y₁, z₁) and a position of the second measurement point is (x₂, y₂, z₂). The processor 110 can calculate the positions from the above-described (distance Li, elevation angle Θᵢ, azimuthal angle Φᵢ) using the following Equation (1).

$${x}_{i} = {L}_{i} \times sin {Θ}_{i} \times cos {Φ}_{i} \qquad ( 1 )$$

$${y}_{i} = {L}_{i} \times sin {Θ}_{i} \times cos {Φ}_{i}$$

$${z}_{i} = {L}_{i} \times cos {Φ}_{i}$$

Then, the processor 110 can calculate the corrected position (x, y, z) by averaging (one aspect of averaging processing) the positions of the first and second measurement points by the following Equation (2) (step S155). The position after correction corresponds to the corrected data.

$$x = ( {x}_{1} + {x}_{2} ) / 2 \qquad ( 2 )$$

$$y = ( {y}_{1} + {y}_{2} ) / 2$$

$$z = ( {z}_{1} + {z}_{2} ) / 2$$

### Averaging Processing in Case Where Distance Between Measurement Points is Greater Than or Equal to Threshold Value

In a case where the distance between the measurement points is equal to or greater than the threshold value (YES in step S140), the averaging processing is performed using the speed data. FIG. 11 is a conceptual diagram showing a state of the averaging processing using the speed data. In FIG. 11, data is acquired at measurement points SP₁₁ to SP₁₇ by scanning in the clockwise direction (first scanning in the first direction), and data is acquired at measurement points SP₂₁ to SP₂₆ by scanning in the counterclockwise direction (second scanning in a direction opposite to the first direction). In the first embodiment, the position of these measurement points is internally divided by the ratio of the absolute values of the speeds at the respective measurement points, and the divided point is set as the position after correction (point group indicated by reference numeral SPt).

Hereinafter, the averaging processing using the speed data will be specifically described. It should be noted that, although the description is simplified in two dimensions, the same processing can be performed in three dimensions.

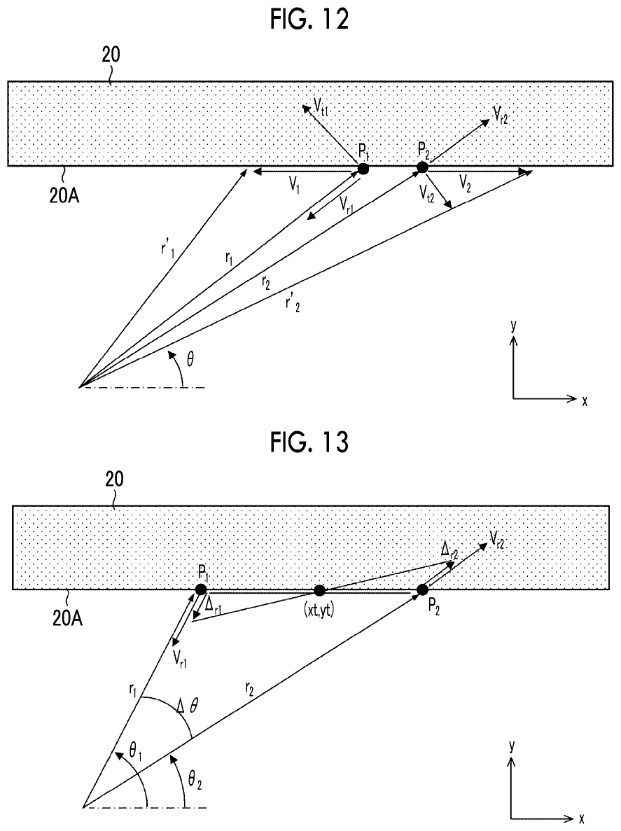

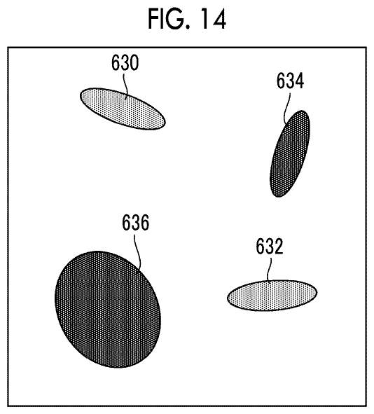

FIG. 12 is a diagram showing a relationship between a visual line direction speed and a tangent line direction speed. In FIG. 12, a subscript “1” indicates a forward scanning (clockwise, first scan), and a subscript “2” indicates a backward scanning (counterclockwise, second scan). The angle θ is measured counterclockwise from the x-axis to the y-axis. In this case, in a case where the angular speeds acquired by the encoder 17 at the measurement points P₁ and P₂ are ω₁ and ω₂, the tangential direction speeds obtained by the forward scanning and the backward scanning are represented by the following Equation (3).

$${V}_{t 1} = {r}_{1} \times {ω}_{1} \qquad ( 3 )$$

$${V}_{t 2} = {r}_{2} \times {ω}_{2}$$

Here, since the angle between V₁ and Vₜ₁ and the angle between V₂ and Vₜ₂ are considered to be equal to each other under the condition that “the positions of the measurement points P₁ and P₂ are sufficiently close to each other”, Expression (4) is established.

$${V}_{r 1} : {V}_{r 2} = {V}_{t 1} : {V}_{t 2} \qquad ( 4 )$$

That is, the speed in the visual line direction and the speed in the tangent direction have different values, but the ratio of the two is the same.

FIG. 13 is a diagram showing a state of internal division of the position by a ratio of absolute values of the speeds. The Doppler shift can be represented by Δf=2×Vₜ/λ in the beat frequency region, and can be represented by Δr=c×Δf/(2τ) in the distance region (λ: wavelength of laser light, τ: chirp plate). Therefore, in a case where the true values of the distances at the measurement points P₁ and P₂ are r₂ and r₂, respectively, the measured values are r+Δr₁ and r₂+Δr₂, respectively. In addition, from the above-mentioned equation of the Doppler shift, Δr₁=Vᵣ₁×c/(λτ) and Δr₂=Vᵣ₂×c/(Δτ) are satisfied. Δr₁ and Δr₂ indicate the influence of the Doppler shift, and “c/(λτ)” is a constant determined depending on the configuration of the laser scanner.

### Internal Division of Position Based on Ratio of Absolute Values of Speeds

As described above, in a case where the true values of the positions of the measurement points expressed in the rectangular coordinates are (x, y) and the measured values are (x′, y′), the relationship between the true values and the measured values at the measurement points P₁ and P₂ is represented by the following Equations (5) and (6).

$${x}_{1}^{′} = {x}_{1} + {V}_{r 1} \times cos {θ}_{1} \times \{ c / ( λτ ) \} \qquad ( 5 )$$

$${y}_{1}^{′} = {y}_{1} + {V}_{r 1} \times sin {θ}_{1} \times \{ c / ( λτ ) \}$$

$${x}_{2}^{′} = {x}_{2} + {V}_{r 2} \times cos {θ}_{2} \times \{ c / ( λτ ) \} \qquad ( 6 )$$

$${y}_{2}^{′} = {y}_{2} + {V}_{r 2} \times sin {θ}_{2} \times \{ c / ( λτ ) \}$$

In Expressions (5) and (6), the second term indicates the influence of the Doppler shift.

By internally dividing the measured values

$$( {x}_{1}^{′} , {y}_{1}^{′} ) and ( {x}_{2}^{′} , {y}_{2}^{′} )$$

by the ratio of the absolute value of Vᵣ, the position (corrected data) of the measurement point from which the influence of the Doppler shift is removed can be calculated as represented by the following expression (7). In Equation (7), it is assumed that Δθ (the difference between θ₁ and θ₂) is sufficiently small and a small amount of first order is negligible.

$${x}_{t} = ( \vert {V}_{r 2} \vert \times {x}_{1}^{′} + \vert {V}_{r 1} \vert \times {x}_{2}^{′} ) / ( \vert {V}_{r 1} \vert + \vert {V}_{r 2} \vert ) \approx ( \vert {V}_{r 2} \vert \times {x}_{1} + \vert {V}_{r 1} \vert \times {x}_{2} ) / ( \vert {V}_{r 1} \vert + \vert {V}_{r 2} \vert ) \qquad ( 7 )$$

$${y}_{t} = ( \vert {V}_{r 2} \vert \times {y}_{1}^{′} + \vert {V}_{r 1} \vert \times {y}_{2}^{′} ) / ( \vert {V}_{r 1} \vert + \vert {V}_{r 2} \vert ) \approx ( \vert {V}_{r 2} \vert \times {y}_{1} + \vert {V}_{r 1} \vert \times {y}_{2} ) / ( \vert {V}_{r 1} \vert + \vert {V}_{r 2} \vert )$$

In addition, in Expression (7), the ratio of the internal division is |Vᵣ₁|:|Vᵣ₂|, but it is also possible to perform the internal division by other ratios. For example, in a case where Δθ cannot be ignored, it is considered to weight the ratio of the internal division for x as |Vᵣ₁|cosθ₁:|Vᵣ₂|cosθ₂ by cosθ and weight the ratio of the internal division for y as |Vᵣ₁|sinθ₁:|Vᵣ₂|sinθ₂ by sinθ. In addition, the same expression is established even in a case where the processing is performed in a polar coordinate system (r, θ) instead of the orthogonal coordinate.

By such processing, the influence of the Doppler shift can be accurately corrected, and the position of the measurement point (the position after correction of the measure portion; corrected data) can be obtained. Then, by repeating the processing of steps S130 to S155 (until YES in step S160), a plurality of pieces of position data (corrected data) of the wall surface 20A (object) can be obtained, and the three-dimensional shape of the wall surface 20A can be measured using the data (step S170).

### Extraction of Damage Candidate Region

The processor 110 can calculate a deviation of the measured three-dimensional shape, the design information of the three-dimensional shape of the wall surface 20A (object), and/or the deviation from the measurement result of the three-dimensional shape acquired in advance, and extract a region in which the magnitude of the deviation exceeds the reference as the damage candidate region (step S180). As the “design information”, for example, three-dimensional data generated from CAD data or the like can be used, and as the “measurement result acquired in advance”, a past measurement result can be used. In addition, the “reference” is, for example, a threshold value of the deviation, and a threshold value set by the user may be used. In addition, the processor 110 can display the extracted damage candidate region on the display device 130 (display device, output device) and/or record the extracted damage candidate region on the recording device 160 (recording device, output device).

FIG. 11 is a diagram showing a state of display of the damage candidate region. Specifically, this is an example of displaying the magnitude of the deviation in the three-dimensional shape (the deviation from the design information of the three-dimensional shape and/or the measurement result of the three-dimensional shape acquired in advance). In FIG. 11, color density indicates the magnitude of the deviation. The larger the color, the larger the deviation, and the deviation is larger in the regions 634 and 636 than in the regions 630 and 632. In such FIG. 11, the processor 110 can superimpose the magnitude of the deviation based on the measurement and the image of the wall surface 20A or the design information and associate (correspond) both with each other. In addition to or instead of the color density, the processor 110 may display the magnitude of the deviation in the chroma saturation, or may display a combination of the color density and a character, a number, a figure, a symbol, a graph, or the like.

In the measurement system 1, the damage may be accurately measured or evaluated by some measurement means (for example, a laser interferometer, noncontact acoustic vibration, image processing, or the like) for the above-described damage candidate region.

The processor 110 may display the measurement result of the three-dimensional shape and the evaluation result of the damage on the display device 130 in time series by a chart, a graph, or the like, and/or may record on the recording device 160. The processor 110 may perform prediction based on the past measurement result (step S190) and output the result (display, recording, or the like). The processor 110 may predict the shape change or the damage by extrapolating the past measurement result with a linear or non-linear function, or may predict the shape change or the damage by using a predictor constructed by machine learning or a prediction model constructed by another method. Such prediction can be reflected in evaluation of damage such as delamination, and planning of inspection, repair, and the like.

Hereinbefore, the embodiment of the present invention has been described, but the present invention is not limited to the above-described aspects, and various modifications can be made.

### EXPLANATION OF REFERENCES

1. Measurement system
10: three-dimensional measurement apparatus
11: laser light source
12: tripod
13: control unit
14: data processing apparatus
15: laser scanner
15A: polygonal mirror
15B: motor
15C: monogon mirror
16: power supply
17: encoder
18: cart
20: tunnel
20A: wall surface
100: measurement apparatus
110: processor
120: memory
130: display device
140: input/output interface
150: operation unit
160: recording device
630: region
632: region
634: region
636: region
P₁: measurement point
P₂: measurement point

What is claimed is:

1. A measurement apparatus comprising:
a processor,
wherein the processor is configured to:
acquire first scan data including information indicating a first distance, which is a distance from a laser scanner to a measure portion of an object, obtained by scanning the measure portion in a first direction with the laser scanner;
acquire second scan data including information indicating a second distance, which is a distance from the laser scanner to the measure portion of the object, obtained by scanning the measure portion in a second direction different from the first direction with the laser scanner; and
calculate corrected data from which influence of a Doppler shift in the first scan data and the second scan data has been removed by applying averaging processing to the first scan data and the second scan data.

2. The measurement apparatus according to claim 1,
wherein the processor is configured to apply the averaging processing according to a distance between a first measurement point at which the first scan data is acquired and a second measurement point at which the second scan data is acquired.

3. The measurement apparatus according to claim 2,
wherein the processor is configured to average a position of the first measurement point and a position of the second measurement point in the averaging processing.

4. The measurement apparatus according to claim 1,
wherein the processor is configured to:
acquire the first scan data including a first speed, which is a speed of the scanning, for each measurement point of a first measurement point group for acquiring the first scan data;
acquire the second scan data including a second speed, which is a speed of the scanning, for each measurement point of a second measurement point group for acquiring the second scan data; and
apply the averaging processing to the first scan data and the second scan data using the first speed and the second speed.

5. The measurement apparatus according to claim 4,
wherein the processor is configured to, in the averaging processing, calculate, as the corrected data, a position obtained by internally dividing a position of a first point, which is a point selected from the first measurement point group, and a position of a second point, which is a point selected from the second measurement point group, in a ratio of an absolute value of the first speed at the first point to an absolute value of the second speed at the second point.

6. The measurement apparatus according to claim 5,
wherein the processor is configured to perform the averaging processing using an internal division ratio of 1:1.

7. The measurement apparatus according to claim 5,
wherein the processor is configured to perform the averaging processing for all pairs of two points that are a pair of the first point and the second point and for which a distance difference between the first point and the second point is equal to or less than a reference value.

8. The measurement apparatus according to claim 5,
wherein the processor is configured to perform the averaging processing for each pair of a point in the first measurement point group and one or a plurality of the second points selected from the second measurement point group in ascending order of distance from the first point.

9. The measurement apparatus according to claim 5,
wherein the processor is configured to perform the averaging processing for each pair of the second point and one or a plurality of the first points selected from the first point measurement point group in ascending order of distance from the second point.

10. The measurement apparatus according to claim 1,
wherein the processor is configured to measure a three-dimensional shape of the object by using a plurality of pieces of the corrected data.

11. The measurement apparatus according to claim 10,
wherein the processor is configured to extract a damage candidate region of the object based on the measured three-dimensional shape and to output information indicating the extracted damage candidate region to an output device.

12. The measurement apparatus according to claim 11,
wherein the processor is configured to extract, as the damage candidate region, a region in which a deviation from design information of the three-dimensional shape of the object and/or a measurement result of the three-dimensional shape acquired in advance exceeds a reference.

13. A measurement system comprising:
the measurement apparatus according to claim 1; and
the laser scanner.

14. The measurement system according to claim 13,
wherein the laser scanner is a laser scanner using laser light of a frequency-modulated continuous wave method.

15. The measurement system according to claim 14,
wherein the laser scanner is a laser scanner using frequency-shift feedback type laser light.

16. A measurement method executed by a measurement apparatus including a processor, the measurement method comprising:
causing the processor to execute:
acquiring first scan data including information indicating a first distance, which is a distance from a laser scanner to a measure portion of an object, obtained by scanning the measure portion in a first direction with the laser scanner;
acquiring second scan data including information indicating a second distance, which is a distance from the laser scanner to the measure portion of the object, obtained by scanning the measure portion in a second direction different from the first direction with the laser scanner; and
calculating corrected data in which an influence of a Doppler shift in the first scan data and the second scan data is removed by applying averaging processing to the first scan data and the second scan data.
